(19) United States
(12) Patent Application Publication
(10) Pub. No.: US 2024/0338105 A1
(43) Pub. Date: Oct. 10, 2024

(54) EXTENDED REALITY SERVICE THAT CUSTOMIZES ACTIONS BASED ON IMMERSIVE PLATFORM TYPES

(71) Applicant: Heizenrader LLC, Lehi, UT (US)

(72) Inventors: Alejandro CASTEDO ECHEVERRI, Sun Prairie, WI (US); Paolo Pariñas VILLANUEVA, Sunnyvale, CA (US); Trevor David PETERSEN, Nephi, UT (US)

(21) Appl. No.: 18/622,440

(22) Filed: Mar. 29, 2024

Related U.S. Application Data
(60) Provisional application No. 63/457,964, filed on Apr. 7, 2023.

(51) Int. Cl. G06F 3/04815; G06F 3/04845; G06F 3/0486; G06T 15/20; G06T 19/20

(52) U.S. Cl. CPC G06F 3/04815; G06F 3/04845; G06F 3/0486; G06T 15/20; G06T 19/20; G06T 2200/24; G06T 2219/2016

(57) ABSTRACT

Techniques for enabling an action to be performed with respect to a hologram that is displayed in a scene are disclosed. A location for a hologram is defined. Defining the location includes defining a triggering action that, when detected, causes the hologram to progressively move from whatever location the hologram is located at a time when the triggering action is detected to the defined location. In response to detection of the triggering action, the hologram progressively moves to the second location.

### CROSS-REFERENCE TO RELATED APPLICATIONS

This application claims the benefit of and priority to U.S. Provisional Patent Application Ser. No. 63/457,964 filed on Apr. 7, 2023 and entitled “EXTENDED REALITY SERVICE THAT CUSTOMIZES ACTIONS BASED ON IMMERSIVE PLATFORM TYPES,” which application is expressly incorporated herein by reference in its entirety.

### BACKGROUND

The phrase “extended reality” (ER) is an umbrella terms that collectively describes various different types of immersive platforms. Such immersive platforms include virtual reality (VR) platforms, mixed reality (MR) platforms, and augmented reality (AR) platforms.

For reference, conventional VR systems create completely immersive experiences by restricting their users' views to only virtual environments. This is often achieved through the use of a head mounted device (HMD) that completely blocks any view of the real world. For instance, FIG. 1 shows an example of an HMD 100 that a user is wearing and using to engage with a three-dimensional (3D) immersive platform. With this HMD 100, a user can be entirely or partially immersed within an immersive environment. Conventional AR systems create an augmented-reality experience by visually presenting virtual objects that are placed in the real world. Conventional MR systems also create an augmented-reality experience by visually presenting virtual objects that are placed in the real world. In the context of an MR system, those virtual objects are typically able to be interacted with by the user, and those virtual objects can interact with real world objects. AR and MR platforms can be implemented using an HMD.

Unless stated otherwise, the descriptions herein apply equally to all types of ER systems, which include MR systems, VR systems, AR systems, and/or any other similar system capable of displaying virtual content. An ER system can be used to display various different types of information to a user. Some of that information is displayed in the form of a “hologram.” As used herein, the term “hologram” generally refers to image content that is displayed by an ER system. In some instances, the hologram can have the appearance of being a three-dimensional (3D) object while in other instances the hologram can have the appearance of being a two-dimensional (2D) object.

Often, holograms are displayed in a manner as if they are a part of the actual physical world. For instance, a hologram of a flower vase might be displayed on a real-world table. In this scenario, the hologram can be considered as being “locked” or “anchored” to the real world. Such a hologram can be referred to as a “world-locked” hologram or a “spatially-locked” hologram that is spatially anchored to the real world. Regardless of the user's movements, a world-locked hologram will be displayed as if it was anchored or associated with the real-world. ER systems have improved significantly in recent years. Despite these improvements, there is an ongoing need to provide improved techniques for interacting with holograms in a scene provided by an ER system.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system that enables an action to be performed with respect to a hologram that is displayed in a scene, said computer system including: a processor system; and a storage system that stores instructions that are executable by the processor system to cause the computer system to: access a hologram that is included as a part of a scene, wherein the hologram is located at a first location within the scene; define a second location for the hologram, the second location being different than the first location in the scene, wherein defining the second location includes defining a triggering action that, when detected, causes the hologram to progressively move from the first location to the second location; detect user input that includes the triggering action; in response to the user input, cause the hologram to progressively move from the first location to the second location, wherein, at a time in which the user input is detected, the hologram is visible within a first perspective view of the scene and the second location is outside of the first perspective view of the scene; concurrently with the progressive movement of the hologram, automatically pan the scene to a second perspective view in which the second location becomes visible; and display the scene from the second perspective view, resulting in the hologram being visible at the second location.

In some aspects, the techniques described herein relate to a method including: accessing a hologram that is included as a part of a scene, wherein the hologram is located at a first location within the scene; defining a second location for the hologram, the second location being different than the first location in the scene, wherein defining the second location includes defining a triggering action that, when detected, causes the hologram to progressively move from whatever location the hologram is located at a time when the triggering action is detected to the second location; detecting that the hologram is at a third location within the scene; detecting user input comprising the triggering action; and in response to the user input, causing the hologram to progressively move from the third location to the second location.

In some aspects, the techniques described herein relate to a method implemented by a head mounted device (HMD), the HMD being a first immersive platform of a first type, said method including: accessing a hologram that is included as a part of a scene, wherein the HMD displays the scene in a three-dimensional (3D) manner; determining that a second location has been defined for the hologram, wherein said determining includes identifying that the hologram is associated with a triggering action that, when performed by a user of a second immersive platform that displays the scene in a two-dimensional (2D) manner, causes the hologram to progressively move from whatever location the hologram is at when the triggering action is performed to the second location without further user input beyond that of the triggering action; facilitating a 3D movement of the hologram from the first location to a third location; detecting that the second immersive platform is concurrently accessing the scene; in response to detecting the triggering action being performed from the user of the second immersive platform, visualizing the hologram progressively moving from the third location to the second location; and determining that the hologram is at the second location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of an HMD.

FIG. 2 illustrates an example architecture.

FIGS. 3A and 3B illustrate examples of a scene.

FIG. 4 illustrates an example of a scene.

FIG. 5 illustrates an example of a scene.

FIG. 6 illustrates an example of a scene.

FIG. 7 illustrates an example of a scene.

FIG. 8 illustrates an example of a scene.

FIG. 9 illustrates an example of a scene.

FIG. 10 illustrates an example of a scene.

FIG. 11 illustrates an example user interface.

FIG. 12 illustrates an example user interface.

FIG. 13 illustrates an example user interface.

FIG. 14 illustrates an example user interface.

FIG. 15 illustrates an example action.

FIGS. 16A and 16B illustrate a multiplayer mode.

FIG. 17 illustrates a workflow diagram.

FIG. 18 illustrates an example method.

FIG. 19 illustrates an example method.

FIG. 20 illustrates an example method.

FIG. 21 illustrates an example computer system that can be configured to perform any of the disclosed operations.

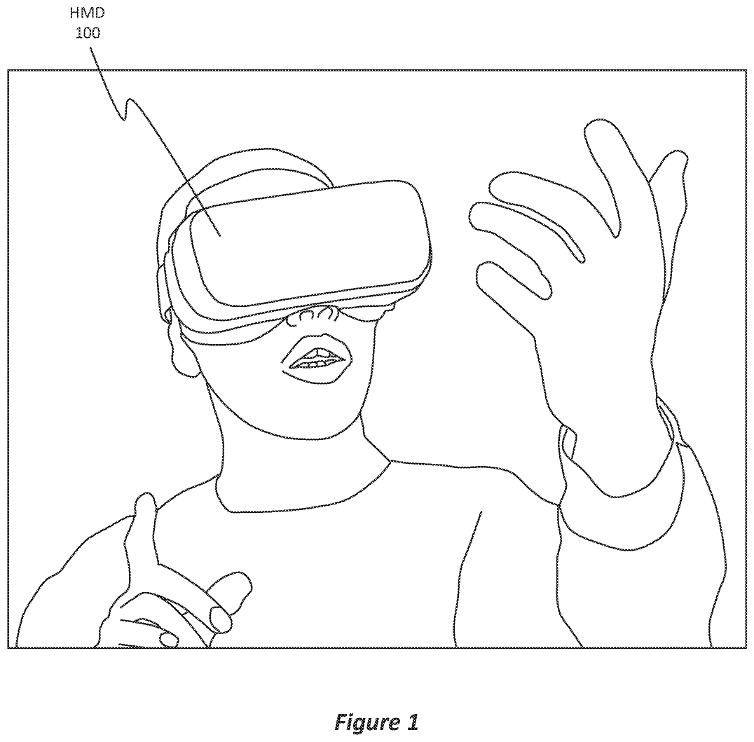

### DETAILED DESCRIPTION

Embodiments disclosed herein relate to systems, devices, and methods for enabling an action to be performed with respect to a hologram that is displayed in a scene provided by an ER system. This hologram is commonly accessible by a first immersive platform of a first type and a second immersive platform of a second type. The first type can be any one of a VR platform, an AR platform, or an MR platform. The second type can be a different one of the VR platform, the AR platform, or the MR platform. It is typically the case that the VR platform displays content in a three-dimensional (3D) manner, though in some cases the VR platform can display content in a two-dimensional (2D) manner. The AR or MR systems can display content in a 3D manner (e.g., using an HMD) or a 2D manner (e.g., using a device in which the content is displayed on a screen). For instance, a touchscreen tablet can optionally be implemented as a VR, AR, or MR system, and the tablet displays content in a 2D manner. Alternatively, an HMD can optionally be implemented as a VR, AR, or MR system, and the HMD displays content in a 3D manner.

It should be noted how this disclosure references a “3D manner” of display and a “2D manner” of display. When content is displayed in a “3D manner,” it means that the content is displayed using any type of ER system. When content is displayed in a “2D manner,” it means that the content is displayed using a screen-based device, such as a tablet, smartphone, smartwatch, or any other screen-based device.

In any event, the above action occurs via a first manipulation when the action is triggered from within the first immersive platform. That same action, however, occurs via a second manipulation when the action is triggered from within the second immersive platform.

For instance, some embodiments provide access to the scene, where the access is provided simultaneously to both the first immersive platform and the second immersive platform. The embodiments determine that the action, which is to be performed against the hologram, is triggered from within the first immersive platform. The embodiments cause the action to be performed for a first time using the first manipulation, which includes a predefined set of one or more manipulations that are automatically executed against the hologram. Such automatic executions do not require user involvement.

The embodiments subsequently determine that the action is triggered from within the second immersive platform. The embodiments cause the action to be performed for a second time using the second manipulation, which includes a set of one or more manipulations that are determined in real-time and that are executed in real-time. Such real-time executions typically do require user involvement.

The disclosed embodiments improve how a user interacts with a computing device. The embodiments also allow for a scene to be simultaneously rendered and displayed on multiple different types of immersive platforms. Actions that may be low in complexity when performed using one immersive platform may be high in complexity when performed in another immersive platform. The embodiments provide various techniques for reducing the complexity level of these actions in the different immersive platforms to thereby improve the user's experience.

Beneficially, the embodiments are able to define an end position (aka a “B” position) for a hologram as well as an “end event” for the hologram. This end position can be used regardless of what platform the user is using (e.g., an HMD that allows the user to interact with the hologram in a natural manner or a handheld platform that allows the user to utilize a so-called “A-to-B” feature, which will be described in more detail later). Beneficially, the embodiments can facilitate the pre-setup of a scene that will be accessed from the different immersive platforms.

As a simplistic example, consider a scenario where it is desired for a user to bring a hologram to a table. The embodiments allow for the selection of the final position (i.e. the “B” position, which is the table) of the hologram using a user interface. When the scene is displayed not using an HMD, the “A-to-B” option can be triggered, and the user can simply perform a triggering action (e.g., perhaps a double tap). The hologram will then move automatically and progressively to the end position, and the camera will likewise pan to that position. When the scene is displayed using an HMD, the hologram is interactable, so the user can naturally grab the hologram and bring it to the table (i.e. the “B” position) while panning his/her view. Optionally, if the hologram is brought within a threshold distance of the “B” position, the hologram can be snapped to that final position.

Regardless of how the hologram reaches the final position, an “end event” can then be triggered. One example of an “end event” is a notification, such as a “congratulations” notification or some other type of indication. Accordingly, an end position (B) and an “end event” can be defined for a hologram. Different users from different immersive platforms can reach a “success” or final state in different manners, as described herein. Accordingly, these and numerous other benefits will now be described in more detail throughout the remaining sections of this disclosure.

### Example Architecture(s)

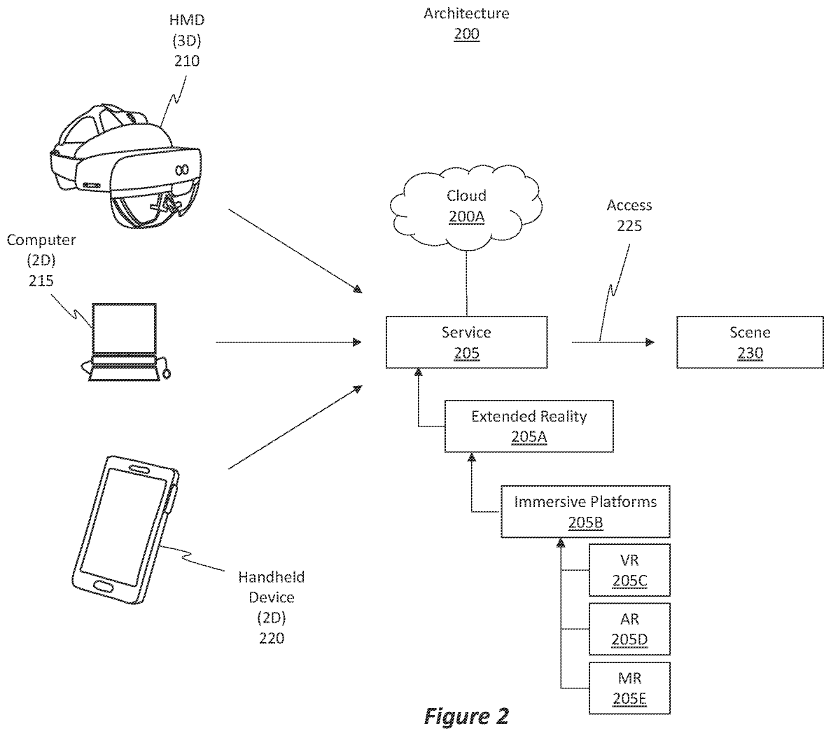

Attention will now be directed to FIG. 2, which illustrates an example architecture 200 that can be used to provide the benefits and advantages mentioned above. Architecture 200 includes a service 205.

As used herein, the term “service” refers to an automated program that is tasked with performing different actions or operations based on input. In some cases, service 205 can be a deterministic service that operates fully given a set of inputs and without a randomization factor. In other cases, service 205 can be or can include a machine learning (ML) or artificial intelligence engine.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 205 is a local service operating locally on a device. In some cases, service 205 is a cloud service operating in a cloud environment 200A. In other cases, service 205 is a hybrid that includes a cloud component operating in the cloud and a local component operating on the device. The local and cloud components can communicate with one another to perform the tasks for the service 205.

Service 205 provides users the option to engage with an extended reality 205A system. There are different immersive platforms 205B that are included in the umbrella term of extended reality. For instance, a VR 205C platform is one type of an immersive platform. An AR 205D platform is another type of immersive platform. An MR 205E is yet another type of immersive platform. Thus, extended reality systems include at least VR, AR, and MR systems.

As an example, the VR 205C platform, the AR 205D platform, and/or the MR 205E platform can all be implemented using a head-mounted device (HMD) 210, which is capable of providing a fully immersive three-dimensional (3D) experience for a user. The VR 205C platform, AR 205D platform, and/or the MR 205E platform can also be implemented using a computer 215 (which is not worn by the user, though it may be held by the user), which is capable of providing a two-dimensional (2D) experience for the user. The VR 205C platform, AR 205D platform, and/or the MR 205E platform can also be implemented using a handheld device 220, which is also capable of providing the 2D experience.

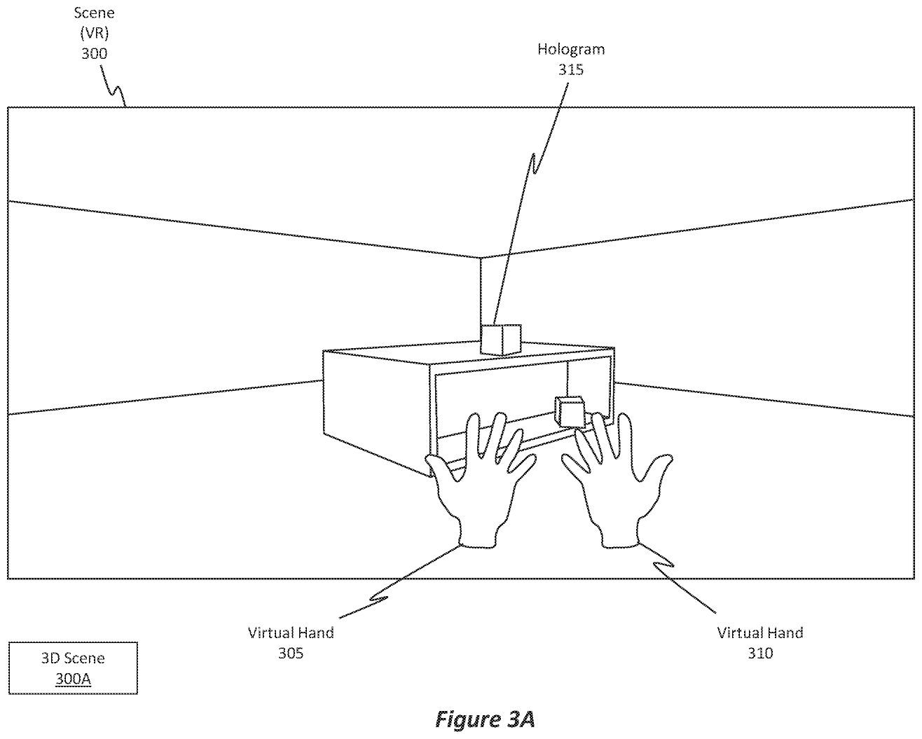

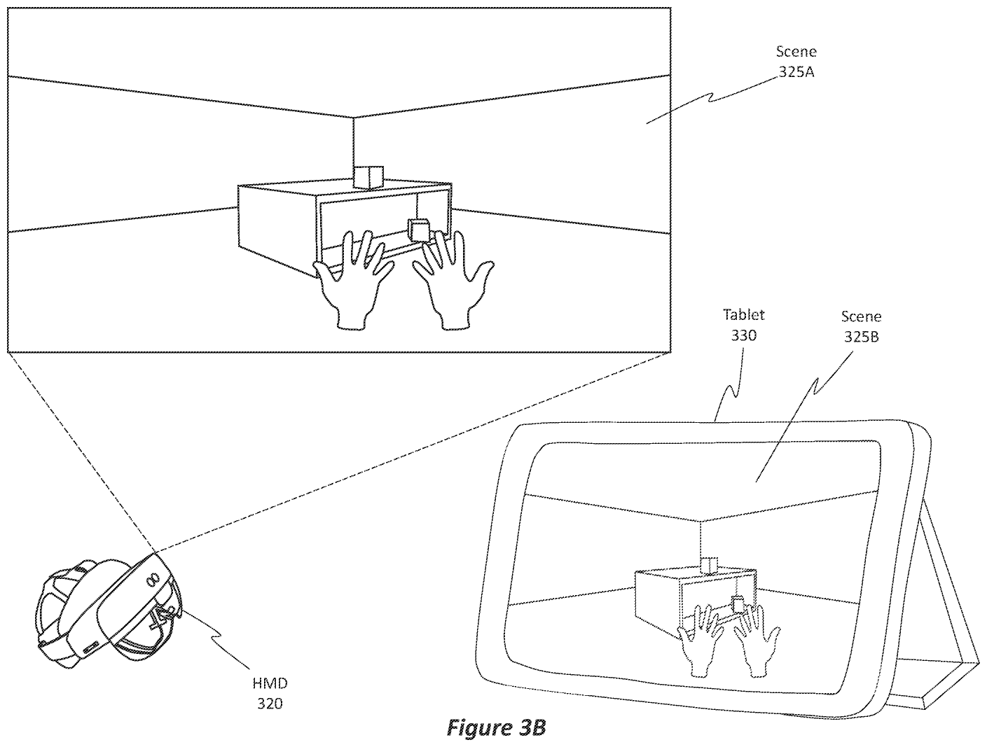

The service 205 is configured to allow one, some, or all of those different immersive platforms 205B to commonly access 225 a computer-generated scene 230. FIG. 3A provides an example of such a scene.

FIG. 3A shows a scene 300, which is representative of the scene 230 from FIG. 2. In this example scenario, scene 300 is being displayed using the HMD 210 of FIG. 2 and is rendered in a 3D manner, as shown by 3D scene 300A. Scene 300 is shown as including a representation of the user's hands, as shown by virtual hand 305 and virtual hand 310. Scene 300 also includes a hologram 315 in the form of a box resting on a table.

As mentioned previously, multiple platforms of different types are able to concurrently or simultaneously access a common scene. FIG. 3B is illustrative.

FIG. 3B shows a scenario in which an HMD 320 is displaying a scene 325A to a user who is wearing the HMD 320. Concurrently, the tablet 330 is displaying the same scene 325B to a user who is viewing the tablet 330. The scene 325A is presented in a 3D manner while the scene 325B is presented in a 2D manner. Stated differently, the scene 325A is presented using an HMD while the scene 325B is presented using a screen.

Notably, the content in the scenes 325A and 325B are the same because those two visualizations represent the same scene even though they are displayed in different manners, or rather, are displayed using different platform types. It is typically the case that the holograms in the scene can be interacted with by the user. Such interactions can occur in a 3D manner or a 2D manner. For instance, the user wearing the HMD 320 will interact with the scene 325A in a 3D manner while the user viewing the tablet 330 will interact with the scene 325B in a 2D manner. If these two users are interacting with the scene at the same time, each user can observe the other user's interactions through each user's respective platform. For instance, the user viewing the tablet 330 can see the interactions of the user wearing the HMD 320, and vice versa.

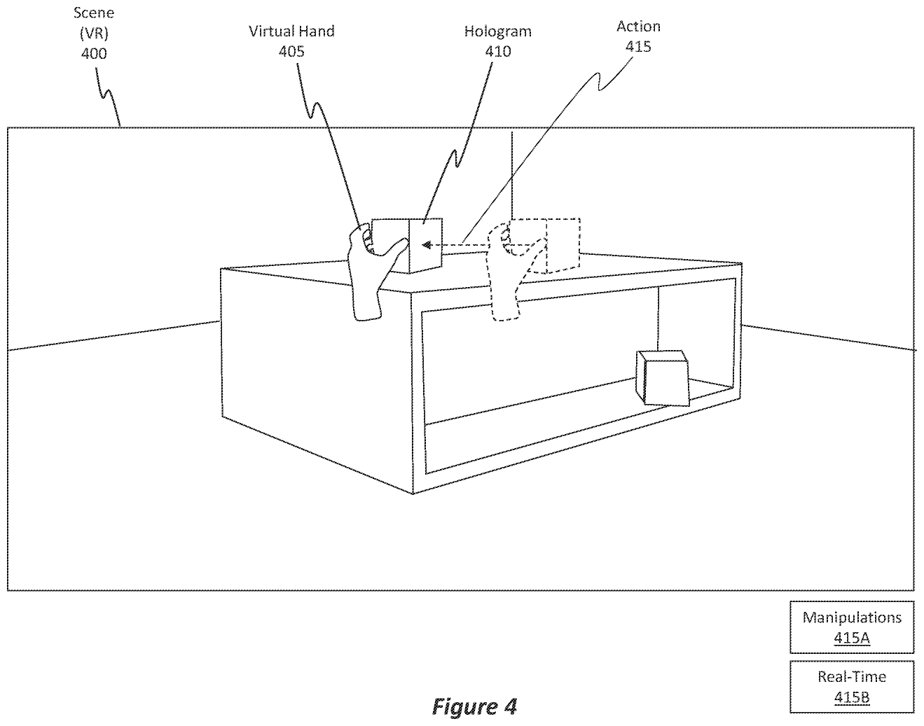

FIG. 4 shows a scene 400, which is representative of the scene 300 from FIG. 3A. Here, the user's virtual hand 405 is interacting with the hologram 410. That is, an action 415 is being executed against the hologram 410. In this example scenario, the action 415 involves one or more manipulations (e.g., manipulations 415A) that are being determined and executed in real-time 415B. The characteristics of the 3D scene are such that holograms can be easily moved or animated by a user within the 3D scene. Action 415 involves moving the hologram 410 from one position on the table to a second position on the table. This action 415 involves a number of manipulations with respect to the hologram 410, as described below.

As various examples, the manipulations include the user's hand “grasping” the hologram 410. The manipulations further include the user's hand, while grasping the hologram 410, moving the hologram 410 from one location to another location. Optionally, the manipulations can further include the user's hand releasing the hologram. These various manipulations are part of an action 415 that is being performed against the hologram 410, where that action 415 generally includes a movement of the hologram 410.

It should be noted how any type of action can be performed using the disclosed embodiments. As some examples, the actions can include, but certainly are not limited to, a movement of a hologram in any of the six degrees of freedom (e.g., yaw, pitch, roll, heaving, surging, or swaying), a functionality associated with a hologram (e.g., perhaps turning a switch on or perhaps turning a key to start an engine), or any other type of feature or function. A majority of this disclosure is focused on actions involving movements of a hologram, but a skilled person will recognize how the principles are broader than just movement actions.

As mentioned above, when a hologram is displayed in a scene provided by an HMD, then the hologram can be interacted with in a manner that mimics how objects are interacted with in real life. For instance, the user's hands are able to pick up and move objects. Due to the characteristics of the scene as provided by the HMD, the level of complexity that is involved with performing these actions is quite low from the user's perspective.

That is, performing various actions are often intuitive while the user is wearing the HMD because those actions reflect or mimic similar actions that are performed in real life. Thus, from the user's perspective, the level of complexity with regard to engaging or interacting with a hologram is often quite low and is often quite intuitive when performed in a 3D scene.

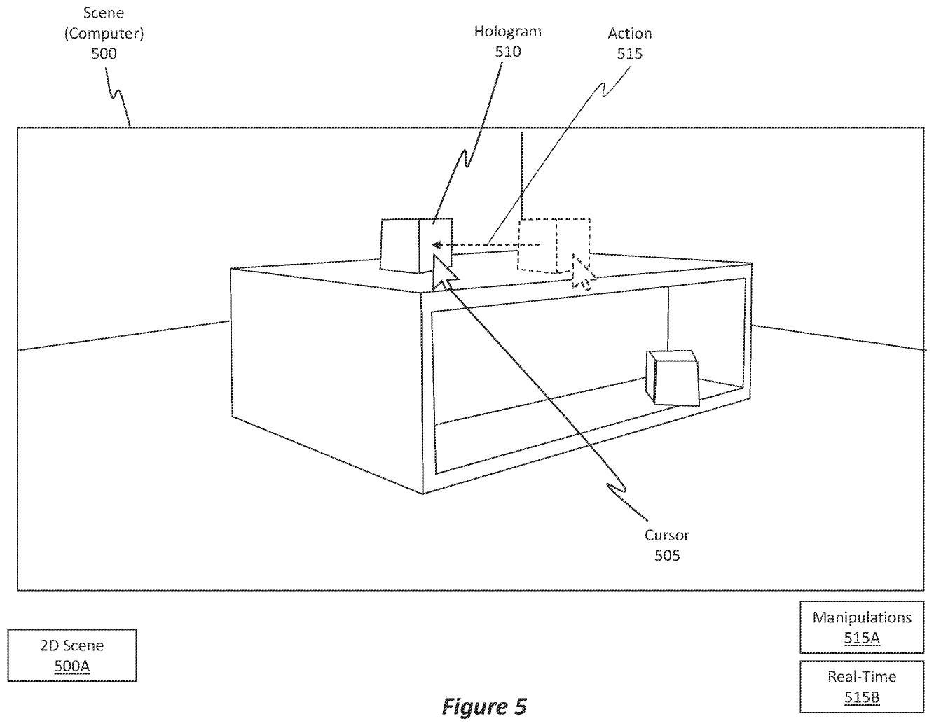

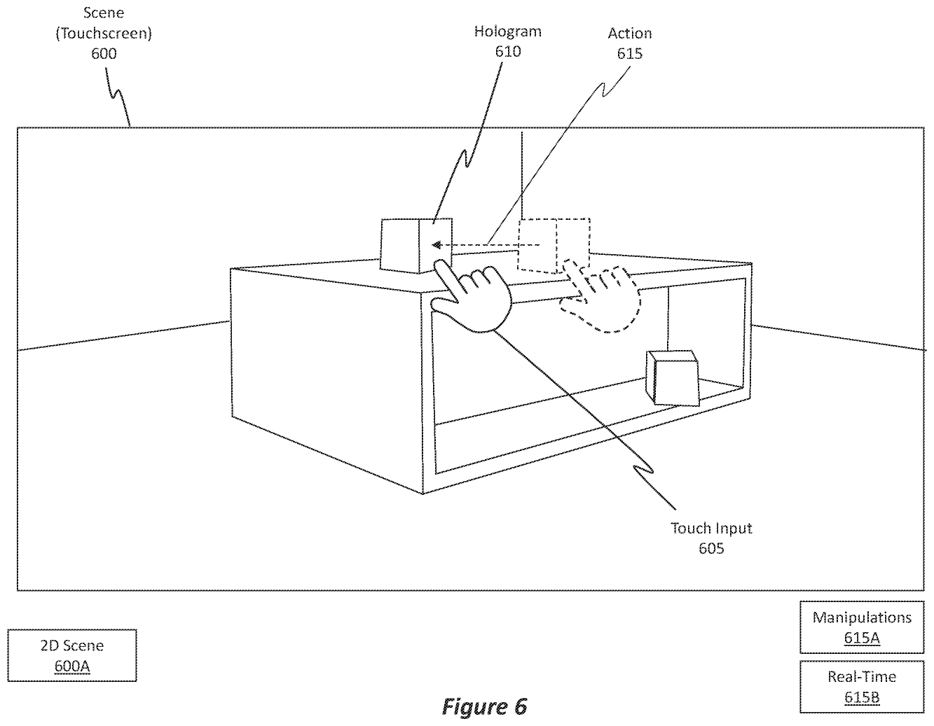

The level of complexity is often quite different when the scene is rendered on a different type of device, such as one that displays content in a 2D manner (e.g., the computer 215 or the handheld device 220 or the tablet 330 of FIG. 3B). FIGS. 5 and 6 are illustrative.

FIG. 5 shows a scene 500 that is displayed in a 2D manner (i.e. it is a 2D scene 500A), such as by displaying the scene 500 on a computer (e.g., laptop, desktop, smart phone, tablet, etc.). Scene 500 corresponds to scene 400 of FIG. 4, though their presentations are different. For instance, scene 400 is presented in a 3D manner while scene 500 is presented in a 2D manner. As described earlier, in some cases, the user immersed in the 3D scene can engage with the same content and at the same time as the user immersed in the 2D scene.

Scene 500 includes a cursor 505 and a hologram 510. In this scenario, an action 515 is being performed against the hologram 510. The action 515 is the same as or sufficiently similar to the action 415 of FIG. 4. That is, action 415 involved moving the hologram 410 from a first position to a second position. Action 515 involves moving the hologram 510 from the same first position to the same second position. More generally, the action 515 involves a movement of the hologram 510. The starting and ending positions of the hologram 510 are not strictly necessary for classifying the action 515 as being similar or the same as the action 415.

In this example scenario, action 515 involves one or more manipulations 515A being performed against the hologram 510, where those manipulations 515A are performed in real-time 515B. These manipulations 515A include, for example, a movement of the cursor 505 to a position that overlaps the hologram 510, performing a clicking action with the cursor 505, and then dragging and dropping (e.g., unclicking) the hologram 510 to the new position.

FIG. 6 shows a scene 600 that is displayed in a 2D manner (i.e. it is a 2D scene 600A), such as by displaying the scene 600 on a touchscreen computer (e.g., laptop, desktop, smart phone, tablet, etc.). Scene 600 corresponds to scene 400 of FIG. 4 and scene 500 of FIG. 5.

Scene 600 includes a touch input 605 and a hologram 610. In this scenario, an action 615 is being performed against the hologram 610. The action 615 is the same or similar to the action 515 of FIG. 5. That is, action 515 involved moving the hologram 510 from a first position to a second position. Action 615 involves moving the hologram 610 from the same first position to the same second position, but this time that action is performed using a different type of input (e.g., a touch input instead of a cursor input). More generally, the action 615 involves a movement of the hologram 610. The starting and ending positions of the hologram 610 are not necessary for classifying the action 615 as being similar or the same as the action 515.

FIGS. 4, 5, and 6 are currently focused on a scenario where the three different users are not currently engaged with the same scene at the same time. Thus, these figures presuppose that the hologram is not being moved by another user. Later figures will demonstrate how that is an option, however.

Action 615 involves one or more manipulations 615A being performed against the hologram 610, where those manipulations 615A are performed in real-time 615B. These manipulations 615A include, for example, a movement of the touch input 605 to a position that overlaps the hologram 610. The manipulations 615A can further include a long press or long hold of the touch input 605 on the hologram 610. The manipulations 615A then include dragging and then dropping (e.g., removing the touch input) the hologram 610 to the new position.

With respect to the manipulations described in FIGS. 5 and 6, a skilled person will recognize how the level of complexity (from the user's perspective) with regard to engaging with a hologram can often be higher when a scene is displayed in a 2D manner as compared to when the scene is displayed in a 3D manner. For instance, when the user is wearing the HMD, the techniques the user uses to manipulate or act upon a hologram often closely reflect or correspond to the techniques the user would use to manipulate or act upon a real-world object. Such techniques are intuitive to the user and can be viewed as being low in complexity (from the perspective of the user) because they reflect real-world techniques. On the other hand, when the user is engaging with the 2D scene, the techniques the user uses to manipulate or act upon a hologram are quite different as compared to the techniques the user would use to manipulate or act upon a real-world object.

To illustrate, with the cursor scenario, the user is required to hover the cursor over the hologram, click, and then drag and drop. With the touch input scenario, the user hovers his/her finger over the hologram, long presses, and then drags and drops the hologram. Manipulating a cursor or touch input is quite different than intuitively grasping an item with a hand. The manipulations that are required to perform an action (e.g., movement of a hologram) in a 3D scene are thus quite different than the manipulations that are required to perform the same action (e.g., movement of the hologram) in a 2D scene. In this sense, the level of complexity for manipulations that are performed to achieve a particular action in a 2D scene are different (e.g., often higher) than the manipulations that are required to perform the same action in a 3D scene.

As will be described in more detail shortly, the embodiments are directed to various techniques that reduce the level of complexity for performing an action in a 2D scene so that those actions can be performed with relative ease, similar to the ease by which those same actions might be performed in a 3D scene.

### Multiplayer Mode

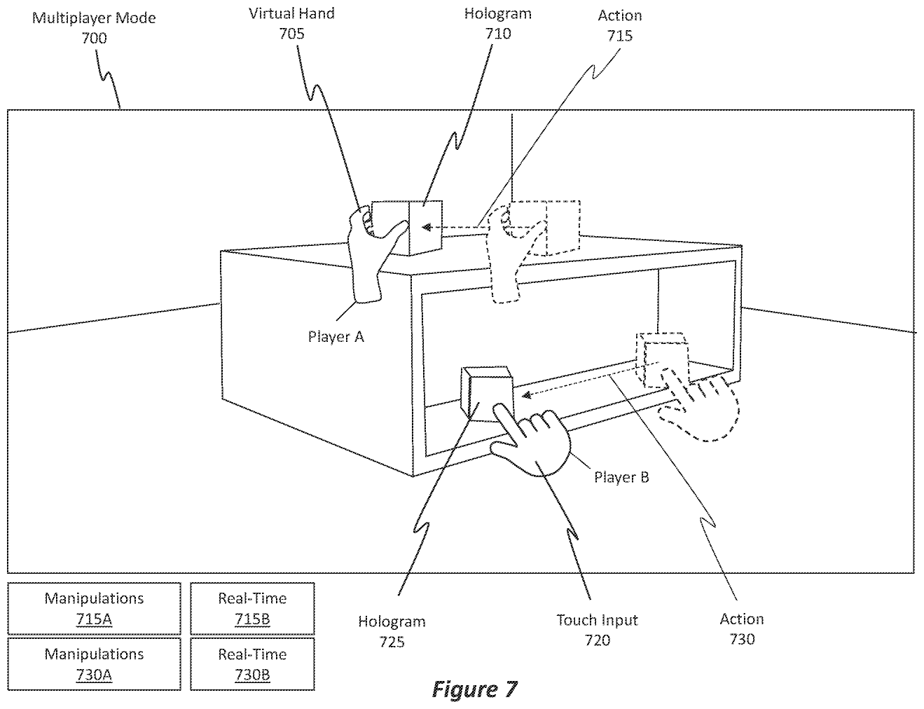

FIG. 7 shows a scene that is provided in a so-called multiplayer mode 700. To illustrate, this scene includes a virtual hand 705 of “Player A,” who is a user that is immersed in a 3D version of the scene using an HMD such that this user views a 3D scene. This scene further includes a hologram 710. An action 715 is being performed against the hologram 710. For instance, the action 715 involves one or more manipulations 715A of the hologram 710 performed in real-time 715B. The manipulations 715A are similar to the manipulations 415A of FIG. 4.

This scene also includes a touch input 720 of “Player B,” who is a user that is immersed in a 2D version of the scene using a 2D touchscreen device such that this user views a 2D scene. Notably, both of these users are immersed in the same scene (though different display versions) at the same time, and both users can observe the actions of each other.

This scene further includes a hologram 725. An action 730 is being performed against the hologram 725. For instance, the action 730 involves one or more manipulations 730A of the hologram 725 performed in real-time 730B. The manipulations 730A are similar to the manipulations 615A of FIG. 6.

Thus, the embodiments enable an action (e.g., an animation, a movement, or any other type of activity) to be performed with respect to a hologram that is displayed in a scene, which is commonly accessible by a first immersive platform of a first type and a second immersive platform of a second type. The action occurs via a first manipulation when the action is triggered from within the first immersive platform. For instance, if the action is a movement, a user in a 3D scene can grab the hologram and move it.

The action occurs via a second manipulation when the action is triggered from within the second immersive platform. For instance, if the action is a movement, the user in the 2D scene can click, long press, etc. the hologram and move it.

The embodiments provide access to the scene to whatever immersive platform is requesting access and has permission. This access can be provided simultaneously to any number of immersive platforms, as described above. For instance, one immersive platform can involve the use of an HMD, and the user of that HMD is provided a 3D immersive experience with respect to the scene. At the same time, a second immersive platform can involve a 2D display device, and the user of that 2D display device is provided a 2D immersive experience with respect to the same scene provided to the HMD user. The HMD immersive platform can be viewed as being a one type of immersive platform while the 2D display device platform can be viewed as being a different type of immersive platform.

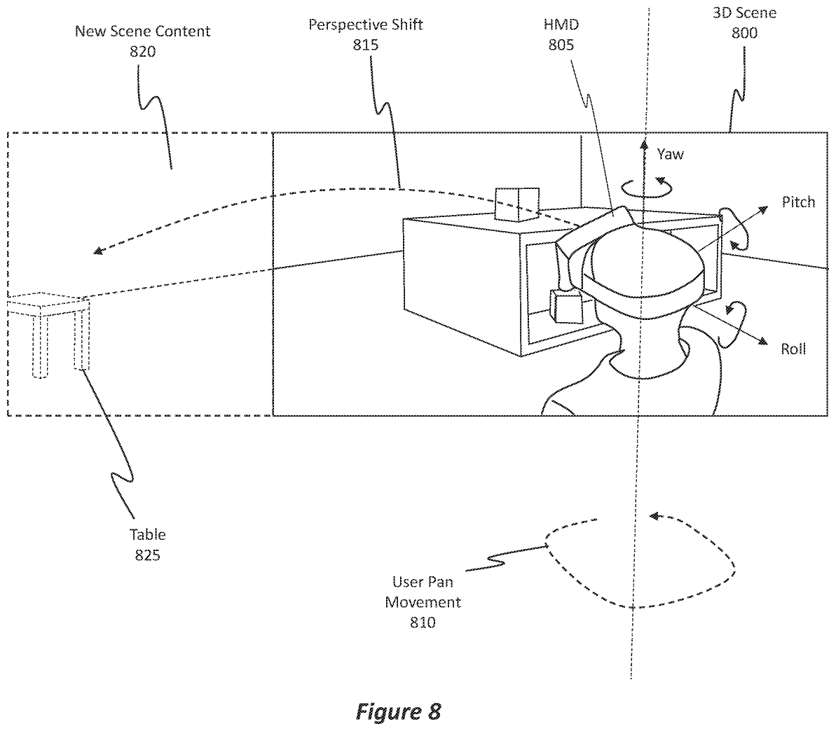

The disclosed embodiments provide various techniques to reduce the level of complexity that may exist when an action is performed in one of the immersive platforms as compared to a different platform. For instance, in the 3D scene scenario, an action may be relatively low in complexity (e.g., from the user's perspective) whereas that same action may be relatively high in complexity when it is performed in a different type of immersive platform. FIGS. 8, 9 and 10 provide some additional examples.

FIG. 8 shows a 3D scene 800 that is being provided to a user who is wearing an HMD 805. The HMD 805 is able to track any type of movement of the user, including any movement in the 6 degrees of freedom. Such movements include yaw, pitch, roll, etc.

In this example scenario, the user is performing a user pan movement 810, which is a yaw type of movement. As a result of this movement, the user's view of the scene changes, as shown by perspective shift 815. Now, new scene content 820, which was not previously viewable by the user, is brought into the user's field of view. Some content that was previously displayed may now not be viewable by the user. In any event, the table 825 is now viewable in the 3D scene 800 by the user.

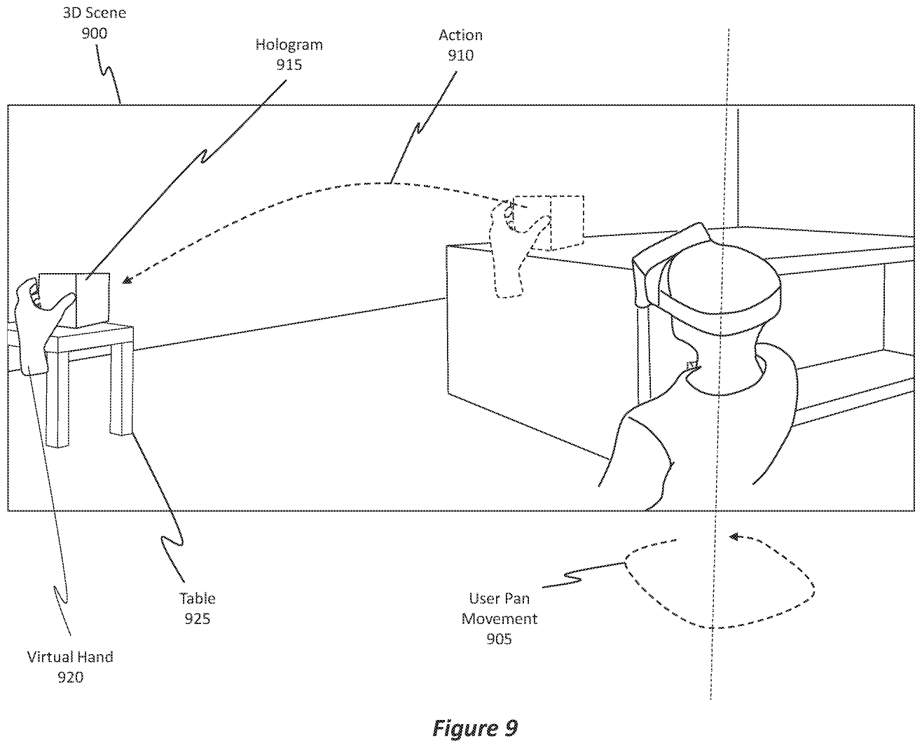

FIG. 9 shows a 3D scene 900 that is representative of the 3D scene 800 of FIG. 8. In this scenario, the user is panning (e.g., as shown by user pan movement 905) while simultaneously performing an action 910 with respect to a hologram 915. More specifically, the action 910 involves the user grabbing the hologram 915 with his/her virtual hand 920, shifting his/her view of the 3D scene which results in a new object (e.g., the table 925) being brought into view, and then placing the hologram 915 on the table 925. Originally, the table 925 was not viewable in the scene. The table 925 became visible within the scene as a result of the user moving.

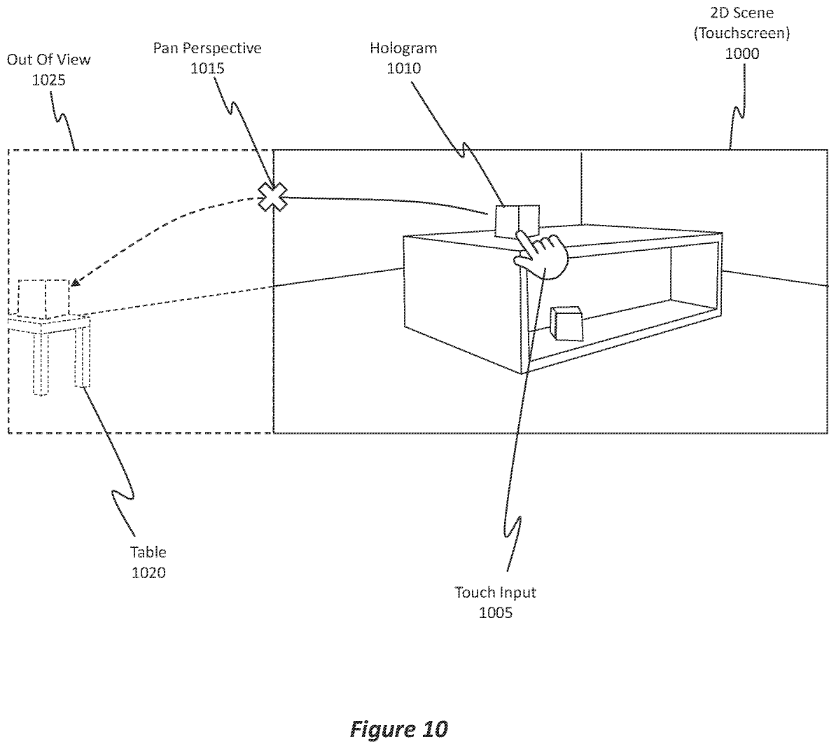

FIG. 9 thus describes a scenario where the user is performing an action that includes a motion of the user and a manipulation of a hologram by the user. The action against the hologram in this example scenario is generally intuitive for the user because such an action mimics how a user would behave in the real world. Now, consider the scenario presented in FIG. 10.

In some cases, the final position (e.g., a “B” position) of the hologram 915 may be predefined. When the user grasps the hologram 915 (e.g., in a scenario where the user is wearing an HMD) and (optionally) brings it to within a threshold distance of the predefined final location, the hologram 915 can automatically be placed or directed to the predefined final position. Thus, in one example scenario, grabbing an object naturally in a scenario involving an HMD can constitute a triggering action for placing the object/hologram at a predefined location. In a scenario not involving an HMD, an “A-to-B” action can be triggered, where the hologram automatically and progressively moves to the predefined final position. As will be described in more detail later, any number of different types of triggering actions may be used to cause a hologram to arrive at a predefined final location/position. For instance, the triggering actions may include, but certainly are not limited to, a grab action, a drag and drop action, a click action, a tap action, a double tap option, and so on.

FIG. 10 presents a 2D scene 1000, which can be displayed to a user via a device, such as a touchscreen device. In this example scenario, the same action 910 performed in FIG. 9 is desired to be performed; now within the context of the 2D scene 1000. Here, the user provides a touch input 1005 to the hologram 1010 and then attempts to move the hologram 1010. In this scenario, however, the panning action is significantly more complex and is not as easy as simply shifting the user's head.

Whereas previously, the user wearing the HMD could simply pan his/her head, now the panning action involves other, non-intuitive actions. To further complicate the matter, that panning action is to be performed while the hologram 1010 is being moved. A skilled person will thus recognize how the complexity for performing the action is significantly higher when attempted in the 2D scene as compared to the 3D scene.

Here, the user is not able to easily pan his/her perspective (e.g., as shown by the “X” over the line labeled as pan perspective 1015). The table 1020 is currently out of view 1025, and the action of moving the hologram 1010 to the table 1020 is significantly more complex. As an example, the user may have to move the hologram 1010 off of the large table, place it on the floor near the edge of the current field of view, pan the field of view until the table 1020 appears, pick up the hologram again, and then place it on the table 1020.

Accordingly, some actions can be easily performed by a user in one type of immersive platform while that same action can be quite difficult to perform by the user in a different type of immersive platform. The term “ease” refers to the level of complexity for performing an action from the user's perspective. The level of complexity can factor in the inclusion of additional manipulations being performed (e.g., pick up, put down, pan, pick up again, and then put down). The level of complexity can also factor in other controls that may be triggered, such as perhaps a zoom in or out, a change to the field of view, and so on. The disclosed embodiments provide various techniques for reducing the complexity involved with performing actions in different immersive platforms.

### Improved Techniques

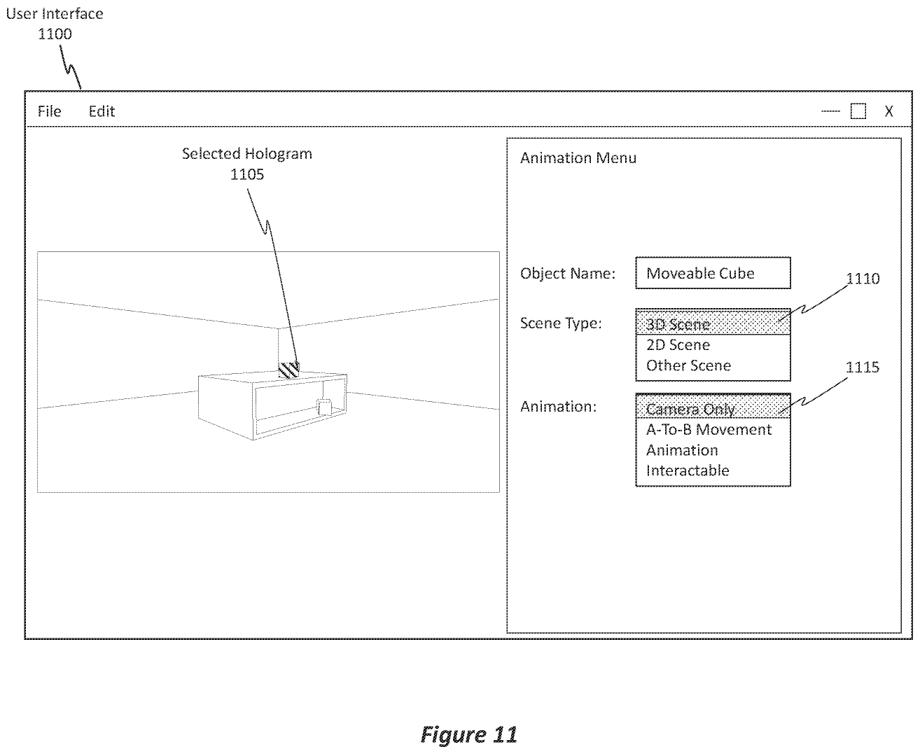

Attention will now be directed to FIG. 11, which illustrates an example user interface (UI) 1100 that provides options to a user to define a set of manipulations that can be automatically performed on a hologram so that certain actions can be easily achieved in different immersive platforms. In this example scenario, a hologram has been selected, as shown by selected hologram 1105. The UI 1100 can then display a number of programmable attributes that can be provided to the selected hologram 1105.

The name of the hologram is provided in the UI 1100, and that name is “Moveable Cube.” A field 1110 allows the user to define different actions that can be performed on the hologram when those actions are triggered in different immersive platforms. In the current scenario, “3D scene” is selected. The other options include, but are not limited to, a “2D scene” and “other scene.” With the “3D scene” option selected, the user can define an action or behavior for the hologram when that hologram is interacted with in a 3D scene.

In this scenario, the field 1115 shows that the “Camera Only” option is selected. The other options include, but are not limited to, “A-To-B Movement”, “Animation”, and “Interactable.”

The Camera Option allows the user to define a perceived position, pose, or field of view of a camera during and/or after an action on a hologram is performed. For instance, the camera can be representative of the field of view of the user wearing a hologram or the field of view of a user viewing the scene from a 2D display. While the action is being performed, the camera's pose can be modified to track the hologram from various different positions or perspectives, as defined by the UI 1100. When the action is complete, the camera's pose can be set to reside at a final location. Thus, the embodiments allow users to define a camera's position, or rather, a field of view that is presented to a user, while an action is occurring or when an action completes.

The A-To-B movement option is an option for defining an end location for a hologram, regardless of where the hologram is originally located. For instance, using the scenario presented in FIG. 11, a hologram is currently displayed on top of a table. The embodiments are able to define a “B” location or a desired final location for the hologram as a result of executing the A-To-B movement. As an example, the final location for the hologram can be set to the floor in front of the table. Regardless of where the hologram is currently located, the triggering of the A-To-B movement option will cause one or more manipulations to be performed on the hologram to cause it to move from whatever its current position is to the final position specified by the option. During the process of defining the A-To-B movement, it may be the case that the final location is currently not displayed in the user's screen. During this definition process, the user can pan to the final location and select that location as the “B” location, which is the defined final location for the hologram. Thus, even though a certain location may not immediately be visible (e.g., the table is not currently visible in FIG. 11), the user can pan or otherwise navigate in any manner so as to bring that final location into the view of the user. Once in the user's view (regardless of whether it is a 3D view or a 2D view), the user can select the location to operate as the final location.

It should be noted how the “B” location may be a predefined location that is predefined using the user interface 1100. When a hologram has a predefined “B” location, the hologram can be caused to move to that location using a number of different techniques. For instance, when operating using an HMD, the user can naturally grab the hologram and place it within a threshold distance of the predefined “B” location. The hologram, according to the programmed logic, will then be triggered to be placed at the “B” location, such as via a snapping action or a progressive movement action to the designated location. In other scenarios, the user may simply place the hologram at the designated “B” location. When the user is not using an HMD, the user can perform some other triggering action (e.g., a tap or click action, a drag and drop action, etc.) to cause the hologram to arrive at the “B” location via an “A-to-B” action, which involves the hologram automatically and progressively moving to the “B” location based on the triggering action (e.g., a double tap of the hologram). Thus, a “B” (or “end” or “final” position) may be defined for a given hologram and different triggering actions can be used to cause the hologram to move to the “B” location.

As another example, consider a scenario where the option is set in the user interface 1100 for the hologram to be “interactable.” In this scenario, in order for this pre-defined action to be “completed,” the user brings the hologram to the B location. That action can be performed, as one example, by the user grabbing the hologram naturally while using the HMD. In another scenario, the user might double click, drag and drop, or perform some other triggering action to cause the hologram to move to the “B” location. Those actions can optionally be performed in scenarios where the user is not wearing the HMD.

In some cases, the user can also predefine a pathway that the object is to travel when going from the A location to the B location. In some cases, the A-To-B movement option includes a configuration setting to cause the selected hologram to avoid collisions with other objects in the scene while moving. In some cases, however, the physicality of those objects is turned off, and the hologram is permitted to pass through any object in a ghost-like manner. Further details on this A-To-B movement will be provided later.

The “Animation” option allows any type of animation to be defined for the hologram. As one example, if the hologram were a key for a car, the animation can include inserting the key into an ignition, turning the key, and starting the car.

The “Interactable” options allows any type of interaction to be made available for the hologram. Such interactions include, but are not limited to, any type of movement, resizing, reshaping, and so on.

As another example, the “interactable” option allows for a user to actually “grab” and manipulate the object in 3D “naturally.” One common use of the disclosed embodiments is to choose the “3D” and “interactable” option and the “2D” and “A-to-B” option. When these options are chosen, the system is able to automatically move the object with a click from 2D and is able to allow the object to be “grabbable” in an HMD scenario.

As mentioned earlier, one beneficial aspect is the ability to involve a defined end position for a hologram. For instance, an end position (e.g., a “B” position) can be chosen when operating in the “interactable” mode, the “A-to-B” mode, or any other type of “animation” mode.

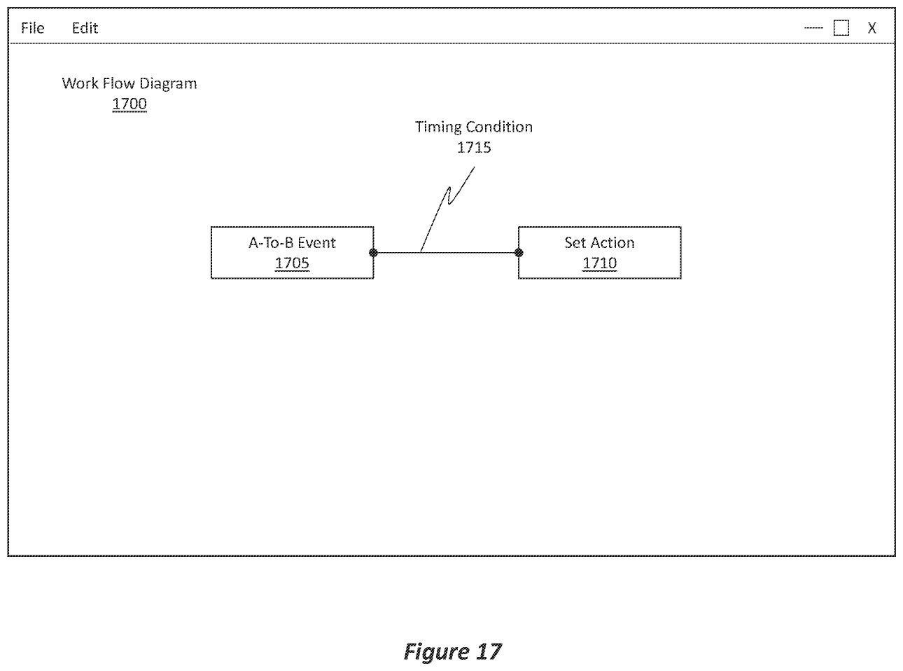

One aspect of the disclosed embodiments is that after defining an end position for a hologram, the user can then decide with the UI how the translation of the hologram is supposed to happen depending on how users access the content (e.g., HMD vs tablet). The embodiments are sufficiently flexible and dynamic to allow users to select a “B” position regardless of how the hologram is to be interacted. As an example, the hologram can be “grasped” and carried to the “B” using the HMD, or the hologram can be clicked and then moved automatically via a tablet. These options satisfy an end event that can be used to do other things (as will be described later in FIG. 17).

By way of further clarification, the term “interactable,” in some implementations, means that any interactions with the hologram are highly dynamic and are not limited to a predefined path or automatic movement. “Interactable” can include grabbing, or more complex interactable actions, such as twisting, resizing, two hand interaction, and so on.

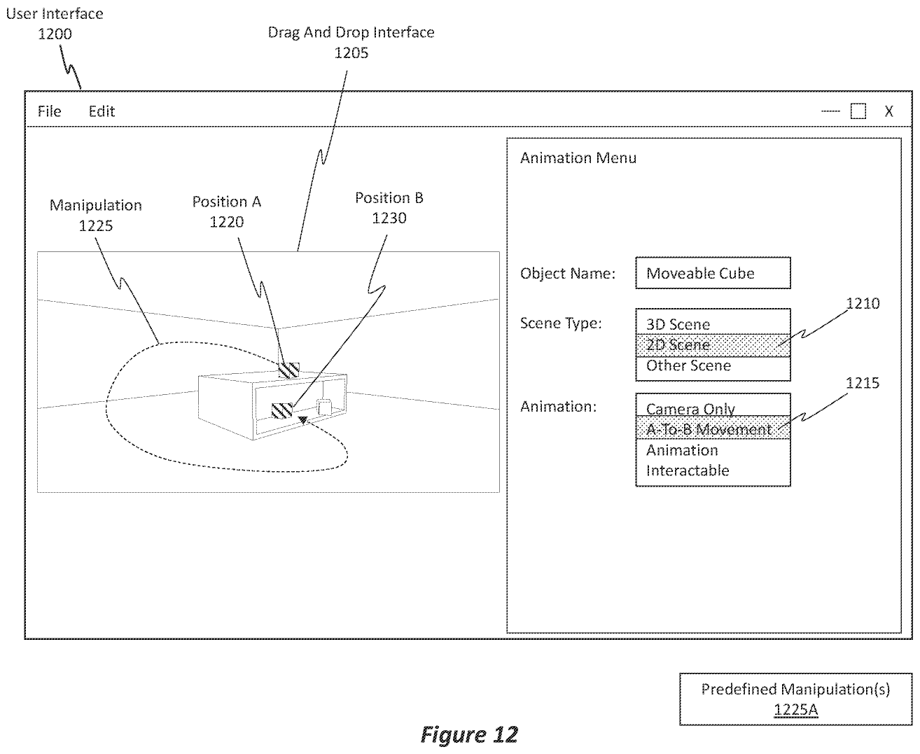

FIG. 12 shows a UI 1200 that includes a drag and drop interface 1205. In this scenario, the 2D scene option has been selected in the field 1210. Also, the A-To-B movement option has been selected in the field 1215. As described previously, the A-To-B movement option allows a user to specify a final location for a selected hologram. Optionally, the pathway taken by the hologram to arrive at that final location can be predefined or it can be generated on-the-fly by the system. The A-To-B movement option is particularly beneficial when moving holograms to a location that is outside of the current field of view of a user immersed in a 2D scene. To be clear, the A-To-B movement is predefined. After the A-To-B movement is defined, a user can be immersed in a 2D scene. If the user desires to engage with the hologram having the defined A-To-B movement, the user can trigger the A-To-B movement and cause the hologram to be automatically moved to the defined final location. If that final location is currently outside of the user's field of view, the user's field of view can track the automatic movement of the hologram, thereby allowing the user to follow the hologram's movement in an easy manner.

FIG. 12 shows a hologram currently located at position A 1220. A manipulation 1225 is performed on the hologram to move it to the defined final location, as shown by position B 1230. Any type of manipulation pathway can be defined or used. In some cases, the pathway is designed to avoid collisions with other objects while in other cases the pathway allows for collisions to occur, and the hologram can simply pass through another object. Accordingly, any number of predefined manipulation(s) 1225A can be defined as a part of the A-To-B movement.

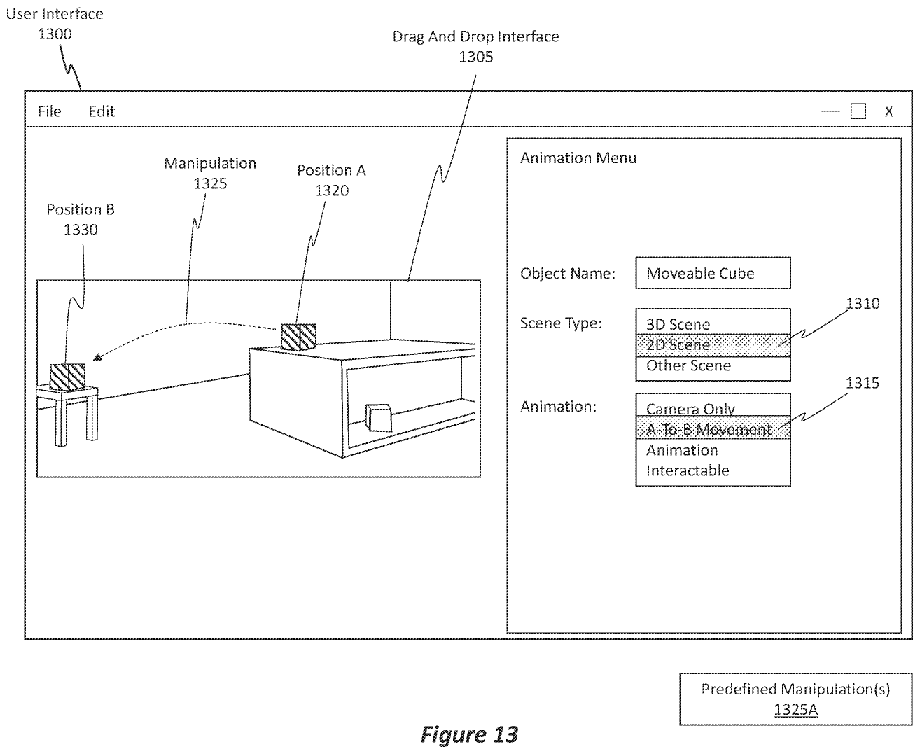

FIG. 13 shows another UI 1300 that includes a drag and drop interface 1305 comprising fields 1310 and 1315. Here, a hologram is currently at position A 1320. A manipulation 1325 (e.g., a movement action) is performed on the hologram, moving it to pre-defined position B 1330. Again, any number of predefined manipulation(s) 1325A can be defined as a part of the A-To-B movement. Optionally, the embodiments allow the user to easily perform any kind of panning or zooming with respect to the scene as it is presented in the UI 1300. When a user is actually engaging with the scene, the A-To-B movement can be implemented, even if the final position is, at that moment, outside of the user's field of view.

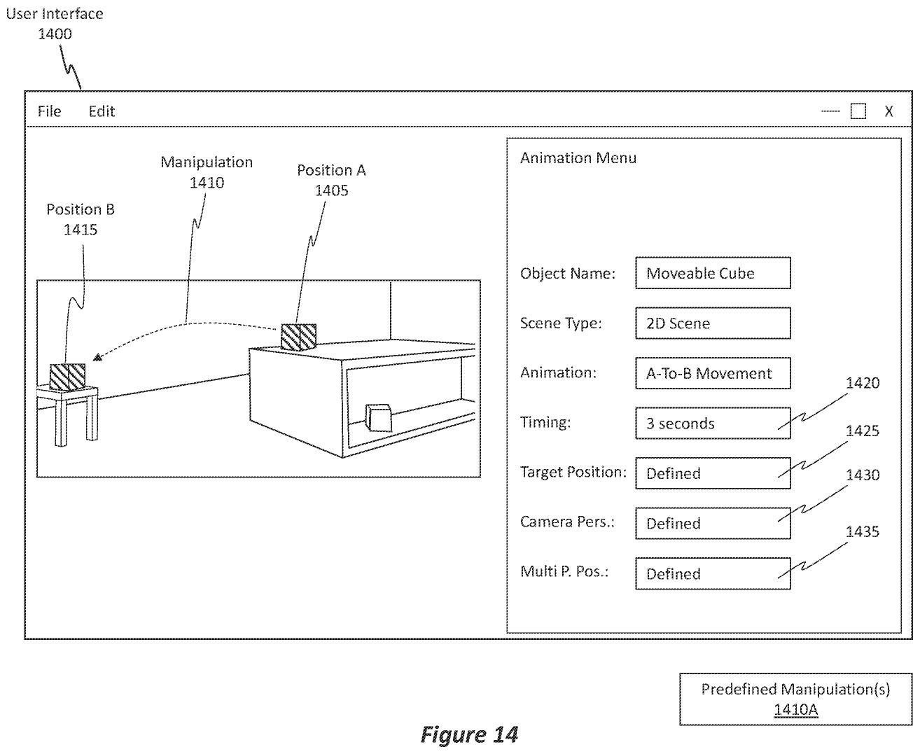

FIG. 14 illustrates another UI 1400 that defines an A-To-B movement for a hologram located at position A 1405. A manipulation 1410 is defined to move the hologram to position B 1415.

UI 1400 also includes fields 1420, 1425, 1430, and 1435. Field 1420 is a field for specifying how long the A-To-B movement is to take (e.g., 3 seconds). Any duration of time can be used. Field 1425 is a field used to define the final position or position B 1415 for the selected hologram. Field 1430 allows a user to specify the perspective or pose of the camera during execution of the A-To-B movement and where the camera will eventually be placed at the end of the A-To-B movement. Field 1435 is a field that allows a user to involve other participants or users in the scene in the A-To-B movement. For instance, field 1435 allows a user to reposition other users or to shift the fields of views of the user's devices when an A-To-B movement is triggered. Accordingly, any number or type of predefined manipulation(s) 1410A can be defined as a part of an A-To-B movement.

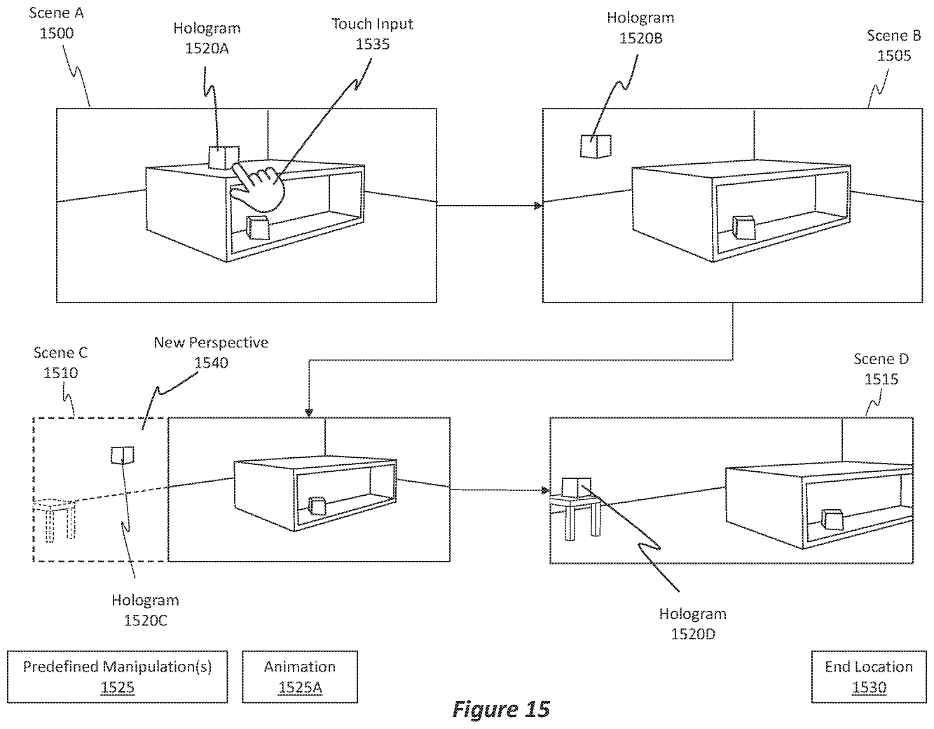

The A-To-B movement is particularly beneficial in the context of a 2D scene (i.e. a scene rendered by a device having a 2D display). For instance, whereas an action involving both a panning of a perspective and a movement of a hologram is relatively not complex in a 3D scene, such an action can be quite complex in a 2D scene, as described previously. Allowing a user to predefine such an action, particularly in the context of a 2D scene, significantly improves the user's later ability to interact with the hologram in a scene. FIG. 15 provides an example.

FIG. 15 shows four scenes, namely, scene A 1500, scene B 1505, scene C 1510, and scene D 1515. Each of the scenes includes the same hologram but at different locations, as shown by holograms 1520A, 1520B, 1520C, and 1520D and at different instances in time. In this scenario, an action has been predefined for the hologram, such as an A-To-B movement. Using the user interfaces that were just described, the user defined one or more manipulations that are to occur to the hologram in response to a triggering event (e.g., perhaps a selection or double tap of the hologram) performed within the context of a 2D scene.

If a user is engaging with the hologram in a 3D scene, the action can be performed in a different way than the way that was defined in the UI for the 2D scene. In this scenario, the defined action is an action of moving the hologram from one position to another, where that movement involves the panning or reframing of the displayed field of view. That is, the action includes one or more predefined manipulation(s) 1525 of the hologram and potentially of the portion of the scene that is currently being displayed to the user. Thus, in some instances, the result of triggering the A-To-B movement includes a movement of the hologram as well as a perspective change for the scene that is being displayed to the user. The action can also optionally include an animation 1525A of the hologram. The predefined manipulation(s) 1525 include the definition of an end location 1530 for the hologram.

As one option, the predefined manipulation(s) 1525 can include a defined pathway the hologram is to follow to travel to the end location 1530. As another option, the predefined manipulation(s) 1525 can include a configuration setting that allows the service (e.g., service 205 from FIG. 2) to determine the current conditions of the scene and to automatically select a pathway that will avoid a collision with another obstacle. As yet another option, the predefined manipulation(s) 1525 can include a configuration setting that allows the service to select any type of pathway, including one where the hologram will simply pass through another object (i.e. the physicality of the object(s) is turned off).

Scenes A, B, C, and D in FIG. 15 show how the hologram, in response to a triggering event (e.g., the touch input 1535) moves from a first location to the end location 1530 and further shows a shift as to which portion of the scene is being displayed. That is, this movement also includes the panning of the field of view to a new location or new perspective 1540 so that previously unseen content (e.g., the table) is now viewable during the execution of the movement action. Whereas previously, such an action was quite difficult to achieve in the context of a 2D scene (e.g., moving a hologram concurrently with panning the scene to display a new perspective), the embodiments enable a user to predefine such an action so that a user immersed in the scene can now perform the action with ease, and this definition further enables automatic modifications to the perspective that is being displayed, if such modifications are warranted (e.g., when the hologram is to be moved to a location that is not currently visible).

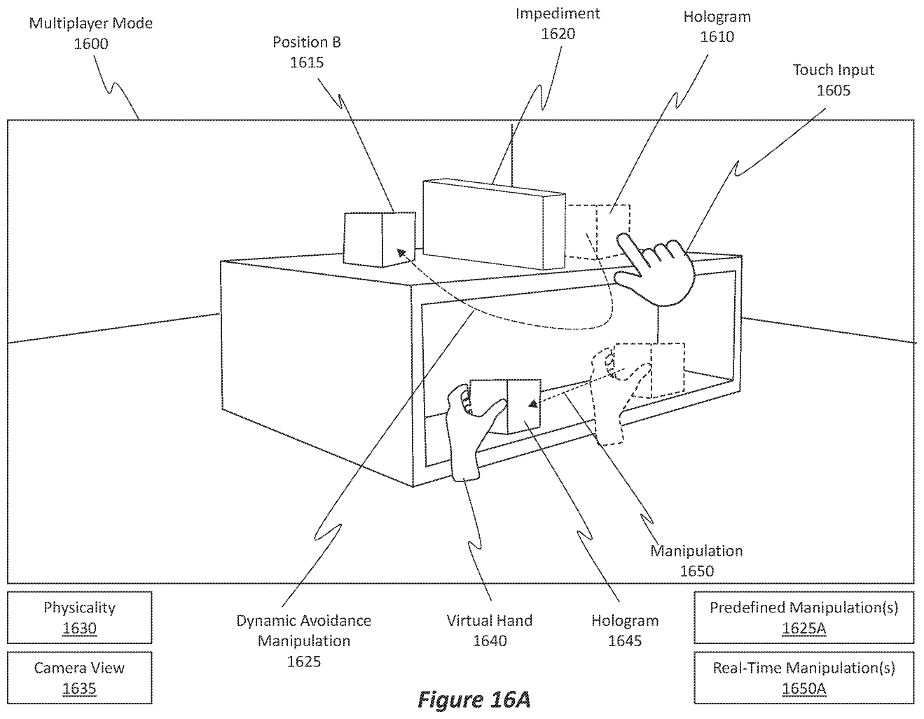

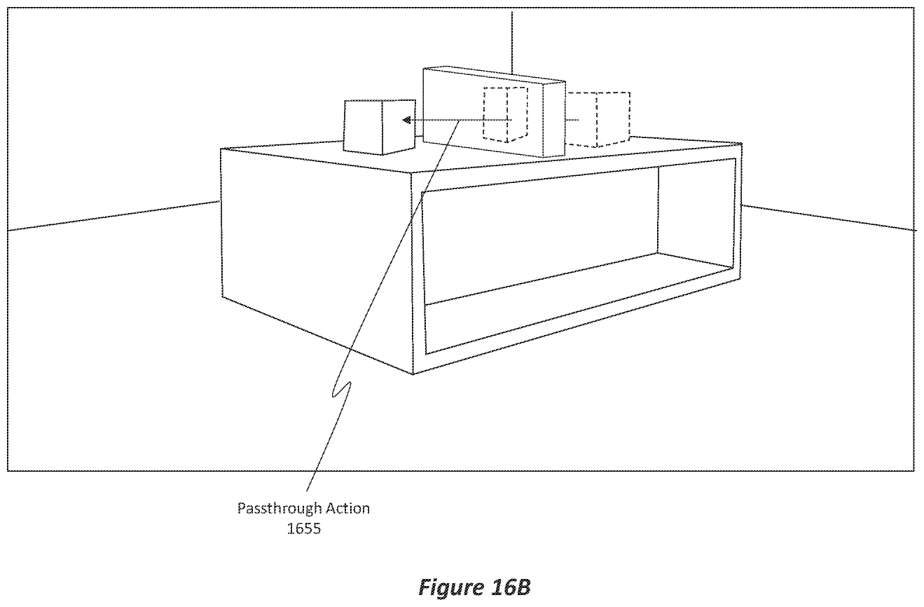

FIG. 16A shows a scenario in which a scene is provided in a multiplayer mode 1600. Here, a first user is viewing the scene using a device that displays 2D content. A second user is simultaneously viewing the same scene using a device that displays 3D content. The first user is providing a touch input 1605 to a hologram 1610. An action was previously defined for that hologram in the form of an A-To-B movement. In particular, when the action is triggered in the 2D scene by the first user (e.g., perhaps by clicking on the hologram 1610 via the touch input 1605), the hologram is caused to move from whatever its current location is to a predefined final position, as shown by position B 1615.

In this example scenario, another object, labeled impediment 1620, blocks the hologram 1610 from moving in a straight line to position B 1615. The action included a configuration setting to allow the hologram 1610 to use a path that will avoid a collision with the impediment 1620, as reflected by the dotted line labeled dynamic avoidance manipulation 1625. Thus, a number of predefined manipulation(s) 1625A have been defined to achieve a particular action with respect to the hologram 1610. At least some of the manipulations are predefined (e.g., the final location) such that at least some of the manipulations are not determined in real-time. In some cases, one or more of the manipulations can be determined and performed in real-time, such as a scenario where the service analyzes the conditions of the scene and dynamically determines a pathway for the hologram to follow. In any event, other than triggering the A-To-B movement, such manipulations can be performed without user involvement or without continuous user involvement.

In this example scenario, the physicality 1630 of the impediment 1620 is not turned off, so the hologram 1610 has to move to avoid the impediment 1620. In other cases, the physicality 1630 is turned off, and the hologram 1610 can pass through the impediment 1620. For example, FIG. 16B shows a passthrough action 1655 in which the physicality of the impeding object is turned off, and the hologram is permitted to pass through that object. Optionally, the camera view 1635 can also be pre-defined, and the camera view 1635 can be updated during the performance of the action.

Returning to FIG. 16A, FIG. 16A shows a virtual hand 1640 of a user who is viewing the 3D version of the scene. In this scenario, that user is performing an action on a hologram 1645, where that action includes a manipulation 1650 in the form of moving the hologram 1645. This manipulation 1650 is an example of a real-time manipulation(s) 1650A because the manipulation is being determined and performed in real-time. As opposed to the A-To-B movement, the action does involve continuous user interaction to move the hologram.

As an example, the embodiments can use the previously described user interfaces to decide that VR users (who have 3D access) can interact with hologram 1610 with the “Interactable” option. As such, the 3D users can simply grab hologram 1610 and bring it to position B 1615, thus satisfying the whole pre-defined interaction. As seen in FIG. 16A, this can be achieved from 2D and from 3D in different manners. Regardless of how it is achieved, once hologram 1610 arrives to position B 1615, then the interaction is satisfied and an end event can happen (as in FIG. 17).

FIG. 17 shows a workflow diagram 1700 that allows a user to control various processes, flows, or timing factors for objects. In this scenario, an A-To-B event 1705 (i.e. an A-To-B movement) has been defined. Some other action has also been defined, as shown by set action 1710. In accordance with the disclosed principles, a timing condition 1715 can be defined to control the execution of events. Here, the set action 1710 is performed subsequent in time to the A-To-B event 1705. In this respect, an “end event” happens, and that end event is “triggered” when the hologram reaches its final destination B, in any manner and from any 3D or 2D access.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

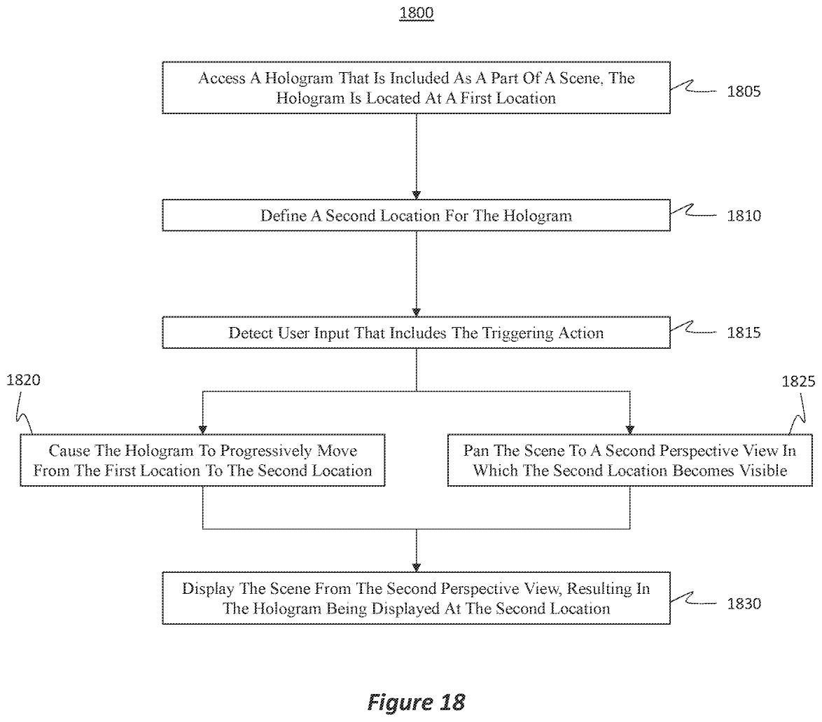

Attention will now be directed to FIG. 18, which illustrates a flowchart of an example method 1800. Method 1800 enables an action to be performed with respect to a hologram that is displayed in a scene, which is commonly accessible by a first immersive platform of a first type and a second immersive platform of a second type. The action occurs via a first manipulation when the action is triggered from within the first immersive platform (e.g., one of a 3D scene or a 2D scene) and the action occurs via a second manipulation when the action is triggered from within the second immersive platform (e.g., the other one of the 3D scene or the 2D scene).

Method 1800 can be implemented using the architecture 200 of FIG. 2. Further, method 1800 can be implemented by the service 205. Optionally, the computer system performing method 1800 can be of any type. In one scenario, the system's type is a type that provides a two-dimensional (2D) view of the scene, or rather, a type that provides a view of the scene using a screen.

Method 1800 includes an act (act 1805) of accessing a hologram that is included as a part of a scene. The hologram is located at a first location within the scene.

Act 1810 includes defining a second location for the hologram. The second location is different than the first location in the scene. The process of defining the second location includes defining a triggering action that, when detected, causes the hologram to progressively move from the first location to the second location.

Act 1815 includes detecting user input. This user input includes the triggering action. In some scenarios, the triggering action includes a long press cursor or touch action. In some scenarios, the triggering action includes a double tap cursor or touch action. Other actions can be used as well.

In response to the user input, act 1820 includes causing the hologram to automatically and progressively move from the first location to the second location (e.g., without further input from the user beyond that of the initial input comprising the triggering action). Notably, at a time in which the user input is detected, the hologram is visible within a first perspective view of the scene, and the second location is outside of the first perspective view of the scene.

In some instances, the hologram automatically and progressively moves from the first location to the second location throughout a pre-defined time period. The pre-defined time period can be set to any duration. In some instance, the duration is set to any value between (or including) 0.25 seconds and 5 seconds. In some cases, the duration is 0.25 seconds, 0.5 seconds, 0.75 seconds, 1.0 seconds, and so on.

Concurrently with the progressive movement of the hologram, act 1825 includes automatically panning the scene to a second perspective view in which the second location becomes visible. This panning action allows the second location to now become visible to the user.

Act 1830 includes displaying the scene from the second perspective view, resulting in the hologram being visible at the second location. Thus, after the user performs the triggering action, the location of the hologram and even the viewpoint of the scene can be automatically modified to reflect a new location and a new viewpoint. Optionally, when the new location (e.g., the second location) is defined, some embodiments also allow a specific viewpoint of that new location to also be defined. Thus, when the triggering action happens, the embodiments move the hologram to the new location and also pan the viewpoint to the pre-defined viewpoint.

Optionally, a path may be defined for the hologram to follow from the first location to the second location. In some cases, the path is a pre-defined path that is defined prior to the user input being detected. For instance, when the hologram is at the first location or when the hologram is placed at a new location, the path may be defined. Stated differently, the path may be defined in response to the hologram being placed at a new location. In some cases, the path is defined at the time in which the user input is detected, or rather, is defined in response to the user input being detected. Thus, regardless of how many times the hologram moves, the path may be defined after or in response to the user input being detected.

In some instances, an impeding object may be positioned in the direct path from the first location to the second location. Optionally, the hologram can pass through the impeding object as a result of the impeding object having a certain state (e.g., a non-physicality state or a state in which the physicality is turned off) during the time when the hologram is moving. The impeding object may revert back to a physicality state after the hologram has finished moving or after the hologram has fully passed through the impeding object. In some instances, the hologram may pass around the impeding object as a result of the impeding object having a certain state (e.g., a physicality state or a state in which the physicality is turned on, thereby preventing objects from passing therethrough) during the time when the hologram is moving.

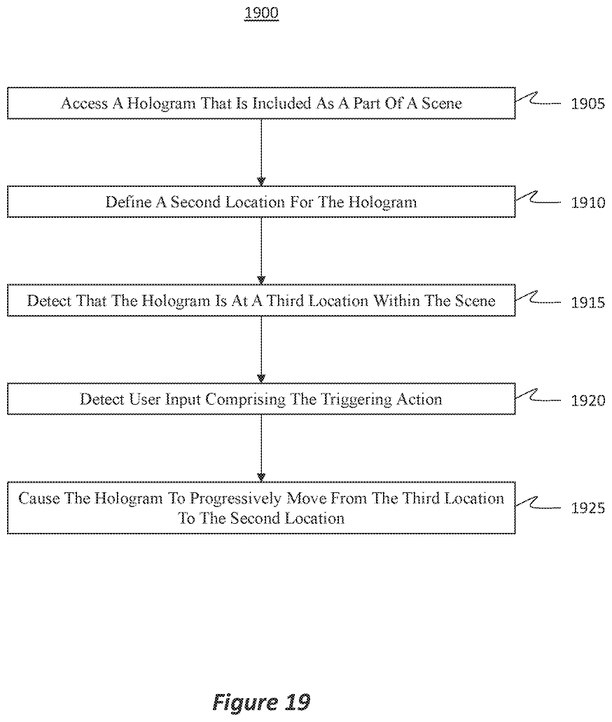

FIG. 19 shows another example method 1900 for facilitating the movement of a hologram. Method 1900 can also be performed by the service 205 of FIG. 2.

Method 1900 includes an act (act 1905) of accessing a hologram that is included as a part of a scene. The hologram is located at a first location within the scene.

Act 1910 includes defining a second location for the hologram. The second location is different than the first location in the scene. The process of defining the second location includes defining a triggering action that, when detected, causes the hologram to automatically and progressively move from whatever location the hologram is located at a time when the triggering action is detected to the second location.

Act 1915 includes detecting that the hologram is at a third location within the scene. The hologram being at the third location may occur as a result of the immediate user moving the hologram to the third location or as a result of a different user moving the hologram. It may even be the case that the hologram moved itself to the new location.

Act 1920 includes detecting user input comprising the triggering action. As mentioned previously, the triggering action may be any action that is predefined.

In response to the user input, act 1925 includes causing the hologram to automatically and progressively move from the third location to the second location. Notably, even though the second location was defined when the hologram was at the first location and even though the hologram is now at the third location, the embodiments still enable the hologram to move to the second location from the third location. Thus, regardless of where the hologram may eventually end up (even after the definition event), the hologram can still travel to the predefined location.

In some cases, method 1900 is performed by a first immersive platform. The hologram can be moved to the third location by a user of a different immersive platform that is concurrently accessing the scene. In some cases, method 1900 is performed by a first immersive platform, and the hologram is moved to the third location by a user of the first immersive platform. In some cases, method 1900 is performed by a first immersive platform; a second immersive platform is concurrently accessing the scene; the hologram is moved to the third location by a user of the second immersive platform; and the first immersive platform displays a movement of the hologram from the first location to the third location.

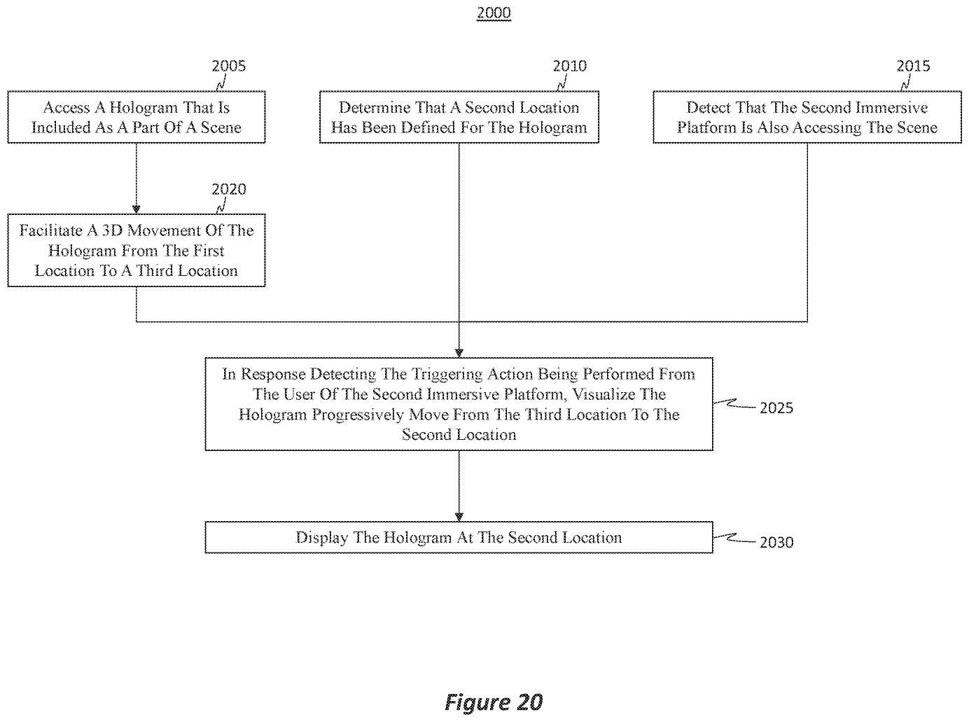

FIG. 20 illustrates a flowchart of another example method 2000 for facilitating the movement of a hologram. Method 2000 can also be performed by service 205. Method 2000 can be implemented by a head mounted device (HMD), where the HMD is a first immersive platform of a first type.

Method 2000 includes an act (act 2005) of accessing a hologram that is included as a part of a scene. The HMD displays the scene in a three-dimensional (3D) manner.

Act 2010 includes determining that a second location has been defined for the hologram. This determination includes identifying that the hologram is associated with a triggering action that, when performed by a user of a second immersive platform that displays the scene in a two-dimensional (2D) manner, causes the hologram to automatically and progressively move from whatever location the hologram is at when the triggering action is performed to the second location without further user input beyond that of the triggering action (e.g., no dragging act is needed on the part of the user). Thus, the predefined movement may be defined (and used) for platforms that display the scene in a 2D manner (e.g., using a tablet or screen-based display). When the scene is displayed in a 3D manner (e.g., using an HMD type of platform), the predefined movement may not be triggered because the user is able to easily and intuitively manipulate the hologram and a predefined movement may not be warranted. Thus, the embodiments are able to determine the type of platform that is being used and, based on the determination of the platform type, are able to determine when (or if) the automatic movement of the hologram is to be triggered.

Act 2015 includes detecting that the second immersive platform is concurrently accessing the scene. The second immersive platform is one that uses a screen to display content as opposed to one that uses an HMD to display content.

Act 2020 includes facilitating a 3D movement of the hologram from the first location to a third location. Notice, the predefined movement was not triggered for the hologram in this scenario because the hologram is being manipulated from an immersive platform that displays the scene in a 3D manner using an HMD.

In response to detecting the triggering action being performed from the user of the second immersive platform, act 2025 includes visualizing the hologram automatically and progressively moving from the third location to the second location. Notice, the predefined movement is triggered in this scenario because the hologram is being manipulated from an immersive platform that displays the scene using a screen as opposed to using an HMD.

Act 2030 includes determining that the hologram is at the second location.

In some cases, the HMD may display the scene from a first perspective view. Optionally, the third location and the second location may both be outside of the first perspective view. In some scenarios, they may be inside of the first perspective view. In some cases, the HMD's view is shifted to track the movement of the hologram while it is occurring. In some cases, the HMD's view might not change, but the HMD may display an indicator (e.g., perhaps a flashing light or a notification or a breadcrumb trail) that the hologram is being moved.

Accordingly, the disclosed embodiments provide various benefits to make actions that are easy in one immersive platform to also be easy in a different immersive platform.

### Example Computer/Computer Systems

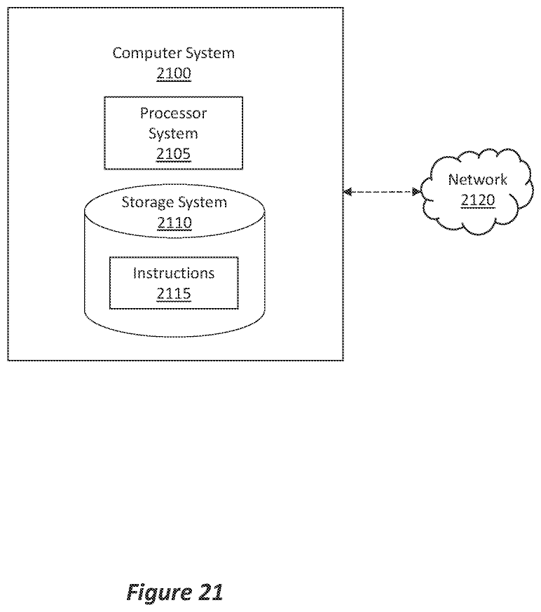

Attention will now be directed to FIG. 21 which illustrates an example computer system 2100 that may include and/or be used to perform any of the operations described herein. Computer system 2100 may take various different forms. For example, computer system 2100 may be embodied as a tablet, a desktop, a laptop, a mobile device, or a standalone device, such as those described throughout this disclosure. Computer system 2100 may also be a distributed system that includes one or more connected computing components/devices that are in communication with computer system 2100.

In its most basic configuration, computer system 2100 includes various different components. FIG. 21 shows that computer system 2100 includes a processor system 2105 comprising one or more processor(s) (aka a “hardware processing unit”) and a storage system 2110.

Regarding the processor(s) of the processor system 2105, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 2100. The different components, modules, engines, and services described herein may be implemented as objects or processors that execute on computer system 2100 (e.g. as separate threads).

Storage system 2110 may include physical system memory, which may be volatile, non-volatile, or some combination of the two. The term “memory” may also be used herein to refer to non-volatile mass storage such as physical storage media. If computer system 2100 is distributed, the processing, memory, and/or storage capability may be distributed as well.

Storage system 2110 is shown as including executable instructions 2115. The executable instructions 2115 represent instructions that are executable by the processor(s) of computer system 2100 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 2100 may also be connected (via a wired or wireless connection) to external sensors (e.g., one or more remote cameras) or devices via a network 2120. For example, computer system 2100 can communicate with any number devices or cloud services to obtain or process data. In some cases, network 2120 may itself be a cloud network. Furthermore, computer system 2100 may also be connected through one or more wired or wireless networks to remote/separate computer systems(s) that are configured to perform any of the processing described with regard to computer system 2100.

A “network,” like network 2120, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 2100 will include one or more communication channels that are used to communicate with the network 2120. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system that enables an action to be performed with respect to a hologram that is displayed in a scene, said computer system comprising:
a processor system; and
a storage system that stores instructions that are executable by the processor system to cause the computer system to:
access a hologram that is included as a part of a scene, wherein the hologram is located at a first location within the scene;
define a second location for the hologram, the second location being different than the first location in the scene, wherein defining the second location includes defining a triggering action that, when detected, causes the hologram to progressively move from the first location to the second location;
detect user input that includes the triggering action;
in response to the user input, cause the hologram to progressively move from the first location to the second location, wherein, at a time in which the user input is detected, the hologram is visible within a first perspective view of the scene and the second location is outside of the first perspective view of the scene;
concurrently with the progressive movement of the hologram, automatically pan the scene to a second perspective view in which the second location becomes visible; and
display the scene from the second perspective view, resulting in the hologram being visible at the second location.

2. The computer system of claim 1, wherein the computer system is a first immersive platform of a first type, the first type of the first immersive platform is a type that provides a view of the scene using a screen.

3. The computer system of claim 1, wherein the triggering action includes one or more of: a long press cursor, a double tap cursor, or a touch action.

4. The computer system of claim 1, wherein the triggering action a movement of the hologram performed by a user.

5. The computer system of claim 1, wherein the hologram progressively moves from the first location to the second location throughout a pre-defined time period.

6. The computer system of claim 1, wherein a path is defined for the hologram to follow from the first location to the second location.

7. The computer system of claim 6, wherein the path is a pre-defined path that is defined prior to the user input being detected.

8. The computer system of claim 6, wherein the path is defined at the time in which the user input is detected.

9. The computer system of claim 1, wherein an impeding object is positioned in a direct path from the first location to the second location, and wherein the hologram passes through the impeding object as a result of the impeding object having a non-physicality state during a time when the hologram is moving.

10. The computer system of claim 1, wherein an impeding object is positioned in a direct path from the first location to the second location, and wherein the hologram passes around the impeding object as a result of the impeding object having a physicality state.

11. A method comprising:
accessing a hologram that is included as a part of a scene, wherein the hologram is located at a first location within the scene;
defining a second location for the hologram, the second location being different than the first location in the scene, wherein defining the second location includes defining a triggering action that, when detected, causes the hologram to progressively move from whatever location the hologram is located at a time when the triggering action is detected to the second location;
detecting that the hologram is at a third location within the scene;
detecting user input comprising the triggering action; and
in response to the user input, causing the hologram to progressively move from the third location to the second location.

12. The method of claim 11, wherein the method is performed by a first immersive platform, and wherein the hologram is moved to the third location by a user of a different immersive platform that is concurrently accessing the scene.

13. The method of claim 11, wherein the triggering action includes at least one of a long press cursor or touch action or a double tap cursor or touch action.

14. The method of claim 11, wherein a path is defined for the hologram to follow from the third location to the second location, the path being defined prior to the user input being detected.

15. The method of claim 11, wherein a path is defined for the hologram to follow from the third location to the second location, the path being defined in response to the user input being detected.

16. The method of claim 11, wherein the method is performed by a first immersive platform, and wherein the hologram is moved to the third location by a user of the first immersive platform.

17. The method of claim 11, wherein:
the method is performed by a first immersive platform,
a second immersive platform is concurrently accessing the scene,
the hologram is moved to the third location by a user of the second immersive platform, and
the first immersive platform displays a movement of the hologram from the first location to the third location.

18. A method implemented by a head mounted device (HMD), the HMD being a first immersive platform of a first type, said method comprising:
accessing a hologram that is included as a part of a scene, wherein the HMD displays the scene in a three-dimensional (3D) manner;
determining that a second location has been defined for the hologram, wherein said determining includes identifying that the hologram is associated with a triggering action that, when performed by a user of a second immersive platform that displays the scene in a two-dimensional (2D) manner, causes the hologram to progressively move from whatever location the hologram is at when the triggering action is performed to the second location without further user input beyond that of the triggering action;
facilitating a 3D movement of the hologram from the first location to a third location;
detecting that the second immersive platform is concurrently accessing the scene;
in response to detecting the triggering action being performed from the user of the second immersive platform, visualizing the hologram progressively moving from the third location to the second location; and
determining that the hologram is at the second location.

19. The method of claim 18, wherein the triggering action includes at least one of a long press cursor or touch action or a double tap cursor or touch action.

20. The method of claim 18, wherein the HMD displays the scene from a first perspective view, and wherein the third location and the second location are both outside of the first perspective view.
